(19) United States
(12) Patent Application Publication
(10) Pub. No.: US 2011/0267169 A1
(43) Pub. Date: Nov. 3, 2011

(54) Method For Determining the Configuration Of a Danger Warning System, and Danger Warning System

(76) Inventors: Urs Kästli, Mannedorf (CH); Karen D. Lontka, Randolph, NJ (US)

(21) Appl. No.: 11/886,299

(22) PCT Filed: Mar. 9, 2006
(86) PCT No.: PCT/EP06/60600

§ 371 Date: May 23, 2011

(30) Foreign Application Priority Data
Mar. 15, 2005 (EP) 05005564.9

(51) Int. Cl. G05B 23/02

(52) U.S. Cl. 340/3.44; 340/3.43

(57) ABSTRACT

A danger warning system has a central station and appliances which are connected thereto by a monitoring line. Each appliance has an insulator switch, an unequivocal identification number, and a communication address. In order to determine the configuration of the danger warning system, the appliances that can be decoupled by the insulator switch are sequentially started and announced to the central station. In the event of simultaneous announcements of more than one appliance, only the announcement of one of said appliances is accepted. During the announcement of appliances at the central station with the communication addresses thereof, when appliances with different communication addresses are simultaneous announced, the communication addresses are differed according to an arbitration method, and the two different communication addresses are sequentially registered. When appliances with the same communication addresses are simultaneously announced, the collision of said same communication addresses is identified and resolved.

### CROSS REFERENCE TO RELATED APPLICATIONS

This application is based on and hereby claims priority to PCT Application No. PCT/EP2006/060600 filed on Mar. 9, 2006 and European Application No. EP05005564 filed on Mar. 15, 2005, the contents of which are hereby incorporated by reference.

### BACKGROUND

The present invention relates to a method for determining the configuration of a danger warning system comprising a central station and appliances connected thereto via a signal line, in which danger warning system each appliance has an isolator switch, a unique identification number and a communication address, and the appliances, disconnectable via the isolator switches, can be started sequentially.

In this context “appliances” should be understood to mean, in particular, hazard detectors, but they may also be actuators, such as optical or acoustic alarm transmitters, relays, alarm displays, transmission appliances for transmitting alarms and the like. When “detectors” are referred to in the following description, this should not, in any case, be understood in a restrictive manner.

Such methods, known by the terms chain synchronization or daisy chain, have long been used for determining the arrangement of detectors purely on a stub line or purely on a ring line. In EP-A-0 093 872 a method of this type is described in which, upon activation of the system, all the detectors are disconnected by a change in voltage of the signal line and then are reconnected to the signal line in a time-staggered manner by the switches in such a manner that each detector additionally reconnects a subsequent detector to the line voltage after a predetermined time delay. The detectors contain address memories which are loaded in a predetermined sequence by the central station with the communication addresses of the individual detectors.

In the method described in EP-A-0 093 872 the treatment of branches can be problematic because, after the isolator switch located before a branch has been closed, two detectors or, in the case of multiple branches, more than two detectors suddenly start simultaneously, especially if they do not yet have a unique communication address. Here, it must be assumed that in exchanges of detectors between different signal lines double communication addresses are possible even for pre-addressed detectors.

EP-A-0 485 878 describes a method for determining the configuration of detectors of a danger warning system in which, prior to allocating the communication address to the detectors, the central station must perform a large number of steps, which demands a relatively large amount of time. Determination of the position of a newly-installed detector by restarting the whole system is time-consuming, especially with relatively large networks, and certainly is not efficient. Apart from that, this method does not function with symmetrical branches.

EP-A-0 880 117 describes a method for automatically locating detectors in which the detectors are equipped with means for communicating with neighboring detectors. To locate a detector, all the detectors open their disconnectors and the detector to be located transmits a corresponding message which is received only by its neighbors. The disconnectors are then closed and it is determined which detectors these neighbors are, enabling unambiguous determination of the position of the detector which is to be located. This method is relatively fast, but requires all detectors to be equipped with the communication means mentioned.

### SUMMARY

It is one possible object of the invention to specify a method for determining the configuration of a danger warning system which, even in the case of branched topologies, enables the configuration of the line network to be determined and which functions more quickly and more simply than the known methods.

The inventors propose that, upon starting, the appliances log on sequentially to the central station and, in the event of simultaneous logging-on of more the one appliance, only the logging-on of one of these appliances is accepted.

A first preferred embodiment is characterized in that the appliances log on to the central station with their communication address, and in that, in the event of simultaneous logging-on by appliances with different communication addresses, the communication addresses are distinguished by an arbitration method and the two different communication addresses are sequentially registered.

A second preferred embodiment of the method is characterized in that the appliances log on to the central station with their communication address, and in that, in the event of simultaneous logging-on by appliances with identical communication addresses, the collision of these identical communication addresses is identified and resolved.

A third preferred embodiment of the method is characterized in that the appliances log on to the central station with their identification numbers, and in that sequential logging-on is ensured by an arbitration procedure via the identification number and a unique communication address is allocated to the appliances via the identification number.

A first alternative method of achieving the object is characterized in that, upon starting, the communication addresses of all appliances are polled by the central station and newly-added communication addresses are thereby identified, and in that, in the event of multiple occupancy of communication addresses, the collision of these identical communication addresses is identified and resolved.

A second alternative method of achieving the object is characterized in that, upon starting, the identification numbers of the newly-started appliances are polled by the central station and a unique communication address is allocated to each appliance found.

The inventors further propose a danger warning system with a program-controlled central station to which a plurality of appliances are connected in parallel via a signal line, each of which appliances includes at least a sensor, an isolator switch, evaluation electronics with at least a memory and an individual and unalterable serial number allocated by the manufacturer. The danger warning system is characterized in that the central station includes units to execute the process steps mentioned.

A preferred embodiment of the danger warning system is characterized in that the appliances mentioned are formed by hazard detectors and/or actuators, such as optical or acoustic alarm transmitters, and/or relays and/or alarm displays and/or transmission appliances for transmitting alarms.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic representation of a danger warning system, and

FIG. 2 is a flow chart to clarify the determination of the configuration of a line network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

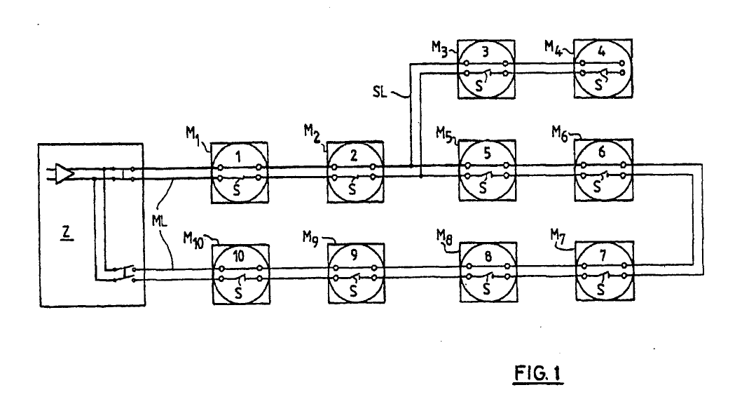

The danger warning system represented in FIG. 1 includes of a central station Z, a ring-shaped signal line ML starting from said central station Z with detectors M₁, M₂ and M₅ to M₁₀ connected to said signal line ML, and a stub line SL branching from the signal line ML with detectors M₃ and M₄ connected thereto. Let the detector M₁ have the communication address 1, the detector M₂ have the communication address 2, and so on. Each of the detectors Mₙ includes at least one sensor for a hazard criterion, such as smoke, temperature or a flammable gas, evaluation electronics (both not shown) and an isolator switch S.

In the case of the danger warning system illustrated it is assumed that each detector Mᵣ, has a communication address and a unique identification number. The latter has been allocated to the respective detector by the manufacturer; it is unalterable and occurs precisely once.

As already mentioned in the introduction to the description, a detector M should be understood to mean not only a hazard detector but quite generally an addressable appliance installed in a signal line. Apart from a hazard detector, this may be an actuator, such as an optical or acoustic alarm transmitter, a relay, an alarm display, a transmission appliance for transmitting alarms, and the like.

In order to determine the configuration of the detectors Mₙ on the network formed by the signal line ML and the stub line SL, the detectors Mₙ, which are disconnectable via the isolator switches S, are started sequentially by the central station Z, a unique communication address being optionally allocated to the detectors. In addition, information from the detectors Mₙ, if present, such as detector type, an identification number such as a serial number or an existing communication address, can be read into the central station Z for complete determination of the configuration of the detectors on the network. Whenever a detector Mₙ has closed an isolator switch S and logged on, the next successive detector closes its isolator switch upon a command from the central station Z. After each closing of an isolator switch S the central station Z waits until no more detectors Mᵣ, log on, and then also knows how many detectors are connected directly behind the one which last closed its isolator switch S. If only one detector has logged on after the last closing of an isolator switch S, no branch is present; if two detectors have logged on there is a single branch, and so on.

The treatment of branches is especially problematic if the detectors at a branch do not already have a unique communication address. In addition, it must be assumed that, through exchange of detectors between different lines, double communication addresses are possible even in the case of pre-addressed detectors, which must be prevented under all circumstances. To master a situation of this kind, therefore, the system must be able to identify that a branch is present, that is, that a plurality of detectors have been started. For this purpose the following methods are proposed:

1. The detectors transmit their communication addresses to the central station Z, which, upon receiving two or more communication addresses simultaneously, prevents the simultaneous logging-on of a plurality of detectors with different communication addresses by an arbitration procedure. In the arbitration procedure the addresses are compared bitwise and the detector which has one bit set, for example, is preferred. This detector then receives a command from the central station Z and closes its isolator switch. Then the communication address of the detector not preferred in the arbitration is read into the central station Z; the detector receives a command from the central station Z and closes its isolator switch S. Then the next detector logs on, and so on.

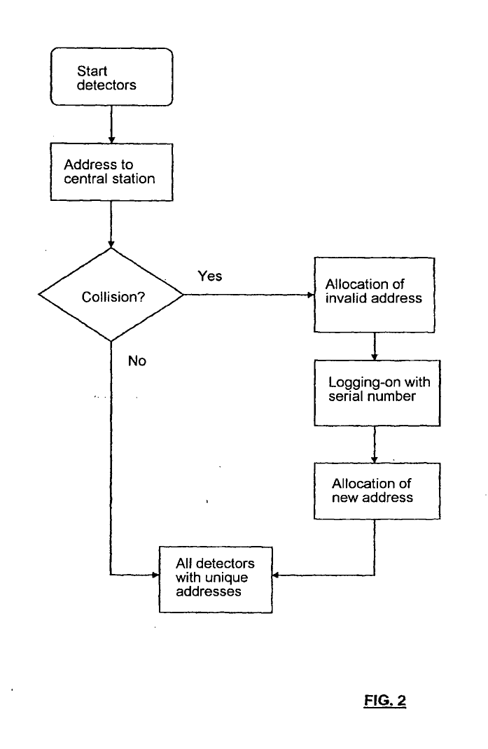

2. The detectors transmit their communication addresses to the central station Z, which identifies the simultaneous arrival of two identical communication addresses as a collision and resolves the collision. The resolution is effected in that the central station Z allocates an invalid communication address to all the detectors involved in the collision, whereupon the detectors with an invalid communication address log on again according to variant 3 (FIG. 2).

3. The detectors log on to the central station Z with their identification number. Sequential logging-on is ensured by an arbitration procedure of the type described and unique communication addresses are allocated to the detectors via the identification numbers.

4. The communication addresses of all detectors are polled by the central station Z, whereby newly-added detectors are identified. Multiple occupancy of communication addresses is identified as a collision and the collision is resolved in the manner already described.

5. The identification numbers of the newly-started detectors are polled by the central station Z (in practice not all possible identification numbers can be polled, because the time required for a large number of multidigit identification numbers would be too long), a method based on a binary search tree being appropriate. A unique communication address is then allocated to each detector found. ,

By using one of the methods described, all detectors directly connected to branch origins are known and starting of each branch can be continued sequentially, so that finally the topology of the whole network can be recorded.

When the danger warning system illustrated in FIG. 1 is started, the isolator switches S of all the detectors Mₙ are opened. The detector M₁, for example, then logs on to the central station Z with its communication address 1, the central station sends the detector M₁ a command to close its isolator switch S and waits for the next detector M₂ to log on, which logging-on takes place analogously. After the detector M₂ has logged on, the two detectors M₃ and M₅ send their respective communication addresses 3 and 5 to the central station Z. The central station registers that a branch must be present and also registers that two detectors with different communication addresses are logging on simultaneously, and applies the arbitration procedure described under point 1, in which the detector M₃, for example, is preferred.

Once the detector M₃ has logged on, the detector M₄ logs on to the central station Z, then the detector M₅, etc. When the detector M₁₀ has logged on, no further detectors log on and the central station Z now knows the configuration of the network of the fire danger warning system. If, for example, because of an exchange of a detector during maintenance/revision work, the detector M₈ had the communication address 3, the central station Z would identify when that detector logged on that the communication address 3 was already allocated to the detector M₃, and would readdress the detector M₈ with a free communication address.

As already mentioned, multiple branching can also be identified with the method described; self-evidently, a limb of a branch may itself contain a branch.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for determining the configuration of a danger warning system comprising a central station and appliances connected thereto via a signal line, each appliance having a unique identification number, a communication address and an isolator switch to disconnect the appliance, comprising:
sequentially starting the appliances;
sequentially logging the appliances on to the central station as each appliance is started; and
in the event of simultaneous logging-on of more than one appliance, accepting only one of the appliances for log on purposes.

12. The method as claimed in claim 11, wherein
the appliances log on to the central station with their communication address, and
if there is a simultaneous log-on by appliances with different communication addresses, the communication addresses are distinguished using an arbitration procedure, which causes two different communication addresses to be registered sequentially.

13. The method as claimed in claim 11, wherein
the appliances log on to the central station with their communication addresses, and
if a collision is caused by a simultaneous log-on of appliances with identical communication addresses, the collision of these identical communication addresses is identified and resolved.

14. The method as claimed in claim 11,
wherein the appliances log on to the central station with their identification numbers, and
sequential logging-on is ensured by an arbitration procedure that allocates unique communication addresses to the appliances via the identification numbers.

15. A method for determining the configuration of a danger warning system comprising a central station and appliances connected thereto via a signal line, each appliance having a unique identification number, a communication address, and an isolator switch to disconnect the appliance, comprising:
sequentially starting the appliances;
polling the communication addresses of all appliances upon starting the central station;
identifying newly added communication addresses through the polling; and
in the event of a collision caused by two or more appliances having identical communication addresses, the collision is identified and resolved.

16. A method for determining the configuration of a danger warning system comprising a central station and appliances connected thereto via a signal line, each appliance having a unique identification number, a communication address, and an isolator switch to disconnect the appliance, comprising:
sequentially starting the appliances;
polling the identification numbers of the appliances as they are started; and
allocating a unique communication address to each appliance.

17. The method as claimed in claim 13, wherein
a log-on collision of two or more appliances is resolved by assigning an invalid communication address to all the appliances involved in the collision,
all appliances with an invalid communication address attempt another log on,
sequential logging-on is ensured by an arbitration procedure that allocates unique communication addresses to the appliances via the identification numbers.

18. The method as claimed in either of claim 12, wherein
the arbitration procedure is carried out by a bitwise comparison of the communication addresses or the identification numbers, and
an appliance which has one bit set is preferred for log-on purposes.

19. A danger warning system, comprising:
a program-controlled central station; and
a plurality of appliances connected in parallel to the central station via a signal line, each appliance including at least a sensor, an isolator switch to disconnect the appliance, evaluation electronics, a memory and an individual and unalterable serial number set by a manufacturer of the appliance,
wherein the central station includes units to execute out the the method claimed in claim 10.

20. The danger warning system as claimed in claim 19, wherein each appliance is selected from the group consisting of a hazard detector, an optical alarm transmitter, an acoustic alarm transmitter, a relay, an alarm display, and a transmission appliance for transmitting an alarm.

21. The method as claimed in claim 15, wherein
a log-on collision of two or more appliances is resolved by assigning an invalid communication address to all the appliances involved in the collision,
all appliances with an invalid communication address attempt another log on,
sequential logging-on is ensured by an arbitration procedure that allocates unique communication addresses to the appliances via the identification numbers.

22. The method as claimed in either of claim 14, wherein
the arbitration procedure is carried out by a bitwise comparison of the communication addresses or the identification numbers, and
an appliance which has one bit set is preferred for log-on purposes.

23. The method as claimed in either of claim 17, wherein
the arbitration procedure is carried out by a bitwise comparison of the communication addresses or the identification numbers, and
an appliance which has one bit set is preferred for log-on purposes.

24. A danger warning system, comprising:
a program-controlled central station; and
a plurality of appliances connected in parallel to the central station via a signal line, each appliance including at least a sensor, an isolator switch to disconnect the appliance, evaluation electronics, a memory and an individual and unalterable serial number set by a manufacturer of the appliance,
wherein the central station includes units to execute out the the method claimed in claim 15.

25. The danger warning system as claimed in claim 24, wherein each appliance is selected from the group consisting of a hazard detector, an optical alarm transmitter, an acoustic alarm transmitter, a relay, an alarm display, and a transmission appliance for transmitting an alarm.

26. A danger warning system, comprising:
a program-controlled central station; and
a plurality of appliances connected in parallel to the central station via a signal line, each appliance including at least a sensor, an isolator switch to disconnect the appliance, evaluation electronics, a memory and an individual and unalterable serial number set by a manufacturer of the appliance,
wherein the central station includes units to execute out the the method claimed in claim 16.

27. The danger warning system as claimed in claim 26, wherein each appliance is selected from the group consisting of a hazard detector, an optical alarm transmitter, an acoustic alarm transmitter, a relay, an alarm display, and a transmission appliance for transmitting an alarm.
